(19) United States
(12) Patent Application Publication
(10) Pub. No.: US 2019/0281790 A1
(43) Pub. Date: Sep. 19, 2019

(54) FLEXIBLE WILDLIFE FEEDER AND CLOSURE

(71) Applicant: Plano Molding Company, Plano, IL (US)

(72) Inventor: Jason P. Campbell, Grand Prairie, TX (US)

(21) Appl. No.: 16/352,405

(22) Filed: Mar. 13, 2019

Related U.S. Application Data
(60) Provisional application No. 62/642,285, filed on Mar. 13, 2018.

(51) Int. Cl. A01K 5/02; F16B 2/08; F16M 13/02

(52) U.S. Cl. CPC A01K 5/02; F16M 13/022; F16B 2/08

(57) ABSTRACT

A gravity animal feeder apparatus is provided that can be quickly and easily setup without assistance. The feeder apparatus comprises a roll top closure that may or may not contain a malleable material to allow the closure to remain in the open position as adjusted by the user for filling. The feeder's gravity design allows use of many formats of feed types to be used individually or simultaneously.

### CROSS REFERENCE TO PRIOR APPLICATIONS

This application claims priority to and the benefit thereof from U.S. Provisional Patent Application No. 62/642,285, filed Mar. 13, 2018, titled “FLEXIBLE WILDLIFE FEEDER AND CLOSURE,” the contents of which are hereby incorporated by reference in their entirety.

### FIELD OF THE DISCLOSURE

The disclosure relates generally to an animal feeder apparatus, and, more particularly to an animal feeder apparatus that comprise a flexible animal feeder device and an closure device.

### BACKGROUND OF THE DISCLOSURE

A variety of animal feeder devices are known. Such devices typically have rigid-walled housing structures that make them costly to manufacture and susceptible to clogging during use.

U.S. Patent Application Publication No. 2015/0128867, titled “Feeding Apparatus, Method, and System” describes a feed bag apparatus that is made of flexible material and is less susceptible to clogging. However, the feed bag apparatus described in this publication is susceptible to unintentional top section feed access by animals such as, for example, raccoons, opossums, squirrels, and varmints. Such animals may claw at and open the top flap partially or wholly, thereby exposing the feed in the feed bag to contamination, rainwater, snow, and consumption by animals the user did not intend to feed with the apparatus.

An unfulfilled need exists for a flexible animal feeder apparatus that is resistant to unintentional top access by animals, compact, easily deployable, and resistant to clogging.

### SUMMARY OF THE DISCLOSURE

According to the principles of the disclosure, an animal feeder apparatus is disclosed that is resistant to unintentional top access by animals, compact, easy to deploy, and resistant to clogging. The animal feeder apparatus of the instant disclosure is compact and quickly deployable, allowing a user (e.g., a hunter) to setup and fill the apparatus within minutes without assistance. The feeder apparatus may be used to feed animals such as, for example, deer, hogs, bears and other wildlife quadrupeds. The feeder apparatus' design allows users to use a number of feed types and formats.

According to one non-limiting embodiment of the disclosure, an animal feeder apparatus is disclosed that comprises a feeder device that has a housing made of a resilient and flexible material such as, for example, flexible PVC fabric that may be formed (or sewn or assembled or glued) into an elongated funnel shape. The top portion of the feeder apparatus comprises a closure device that has a resilient, waterproof material (e.g., PVC fabric) that may be rolled or folded one or more times. The closure device may be integrally formed or assembled with the feeder device to form the feeder apparatus. The closure device has a rim at the uppermost portion of the feeder apparatus that forms an opening. The rim may contain a form member (for example, a piece of malleable metal) to keep the top portion of the feeder apparatus in an open configuration so as to allow the user to fill, clean, or inspect the feed chamber in the feeder apparatus. Once the feeder apparatus has been filled, cleaned or inspected, the top portion may be collapsed, rolled a number of times and then clipped or strapped into the sealed position by means of the sealing member. In the sealed position the feeder apparatus is waterproof, varmint proof and spill proof due to the design. Gravity causes the feed in the feeder apparatus to flow at a controlled rate through the bottom of the apparatus, which may be regulated by close but adjustable proximity to the ground, as animals consume the feed. Reliance on gravitational forces in lieu of mechanical drivers allows the user to feed a plurality of feed types including but not limited to corn, grains, protein pellets, protein powders, attractants, salts and mixtures of the foregoing individually or simultaneously.

The animal feeder apparatus comprises a feeder device and a closure device. The feeder device and closure device may be integrally formed as a single piece, or assembled from multiple pieces. The closure device may comprise the top portion of the feeder device.

The feeder device comprises a flexible housing having a wall with an inner wall surface and an outer wall surface. The housing wall may be tapered at the bottom end of the feeder device so as to control a pass-through rate (or feed rate) of gravity fed feed through an opening formed in the bottom end of the feeder device. The feeder device comprises a feed chamber that is formed by the inner wall surface. The feed chamber may have an elongated funnel shape. The shape of the feed chamber may be adjusted to control the feed rate through the bottom end of the feeder device. The size of the opening at the bottom end of the feeder device may be adjusted to control feed rate.

The feeder device may have a second opening at the top of the feeder device, which is opposite the bottom end. The second opening provides direct access to the feed chamber, so that feed may be poured through the second opening into the feed chamber, or a user may access the feed chamber for cleaning or inspection. The second opening may be closed or opened by means of the closure device.

The feeder device housing wall is flexible and is made of a durable, resilient, and weather-resistant material, which may include, for example, Kevlar®, denier, canvas, nylon, plastic, hemp, cotton, flexible PVC fabric, and the like. The feeder device housing may be formed as a single piece or assembled from more than one piece, which may be sewn, assembled, adhered, or otherwise fastened together to form the feeder device housing.

The feeder device may include one or more mounting fasteners so as to mount the feeder device to an object such as, for example, a tree, a branch, a bush, a pole, a wall, or the like.

The closure device may be integrally formed with or attached to the top portion of the feeder device to form the feeder apparatus. The closure device comprises a sealing member that allows a user to securely close and lock the top end of the feeder apparatus in a closed configuration, thereby preventing access to the feed chamber (or the feed therein) in the feeder device. The closure device may include a form member that maintains a predetermined shape of the top portion of the feeder device. The predetermined shape may include, for example, a circular shape, an elliptical shape, or any other shape that allows for easy access to the feed chamber through the top portion of the feeder device.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a front view of an example of a feeder apparatus in an open configuration, constructed according to the principles of the disclosure.

FIG. 2 shows a back view of the feeder apparatus in the open configuration.

FIG. 3 shows a top-down view of the feeder apparatus in the open configuration.

FIG. 4 shows a front view of the feeder apparatus in a closed configuration.

FIG. 5 shows a top view of the feeder apparatus in the closed configuration.

FIG. 6 shows a side view of the feeder apparatus in the closed configuration.

FIG. 7 shows a top view of the feeder apparatus in the closed configuration.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

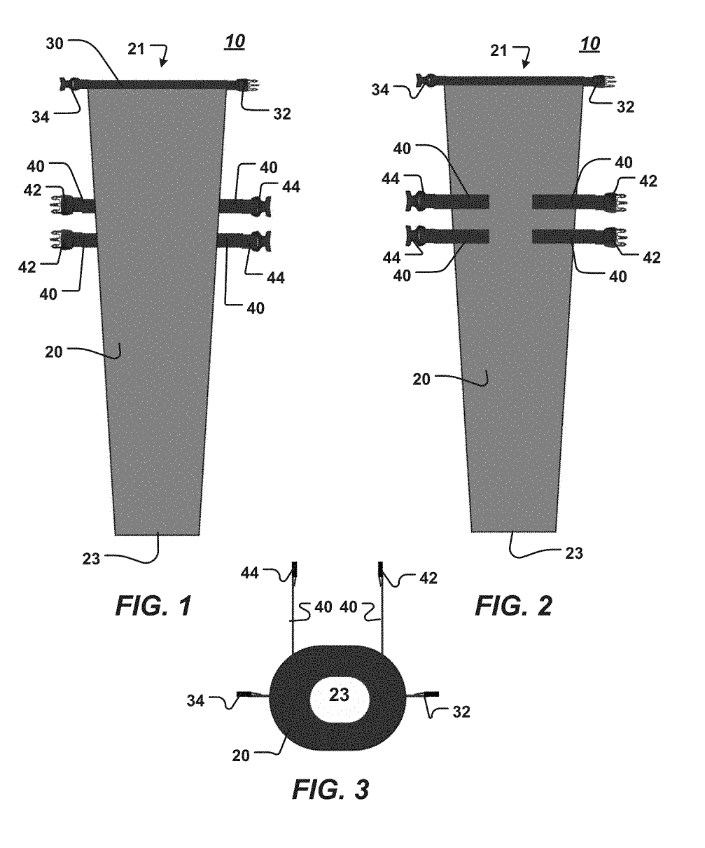

FIG. 1 shows an embodiment of an animal feeder apparatus constructed according to the principles of the disclosure. The animal feeder apparatus comprises a feeder device and a closure device. The feeder device and closure device may be integrally formed as a single piece, or assembled from multiple pieces to form the feeder apparatus.

The feeder device comprises a flexible housing 20 having a housing wall with an inner wall surface (shown in FIG. 3) and an outer wall surface. The housing wall may be tapered at a bottom end of the feeder device so as to control a pass-through rate (or feed rate) of feed through an opening 23 formed in the bottom end of the feeder device. The feed is forced downward in the feeder device and through the opening 23 by gravitational force on the feed. The feeder device comprises a feed chamber (shown in FIG. 3) that is formed by the inner wall surface of the housing 20. The feed chamber may have an elongated funnel shape. The shape of the feed chamber may be adjusted to control the feed rate through the bottom end of the feeder device. The size of the opening 23 may be adjusted to control feed rate.

Referring to FIG. 1, the feeder device has a second opening 21 at the top portion of the feeder device. The second opening 21 provides direct access to the feed chamber, so that feed may be poured through the second opening 21 into the feed chamber, or so that the user may clean or otherwise access the feed chamber through the opening 21. The opening 21 may be closed or opened by means of the closure device.

The feeder device housing wall is flexible and is made of a durable and weather-resistant material, which may include, for example, Kevlar®, denier, canvas, nylon, plastic, hemp, cotton, flexible PVC fabric, and the like. The feeder device housing 20 may be formed as a single piece or assembled from more than one piece, which may be sewn, adhered, assembled, or otherwise fastened together to form the feeder device housing. The closure device may be made of the same material as the feeder device.

The feeder device includes a mounting fastener 40 so as to mount the feeder device to an object such as, for example, a tree, a branch, a bush, a pole, a wall, or the like. In the embodiment shown in FIG. 1, the feeder device comprises four mounting fasteners 40. The mounting fastener 40 may include a strap. The mounting fastener 40 may include a mount lock 42/44, such as, for example, a side release buckle, a tongue-grove fastener, a zipper, a button, a hook-and-loop fastener, or any other device that allows for easy attachment/removal of the mounting fastener 40 and, therefore, the feed apparatus from/to an object such as, for example, a tree or a pole.

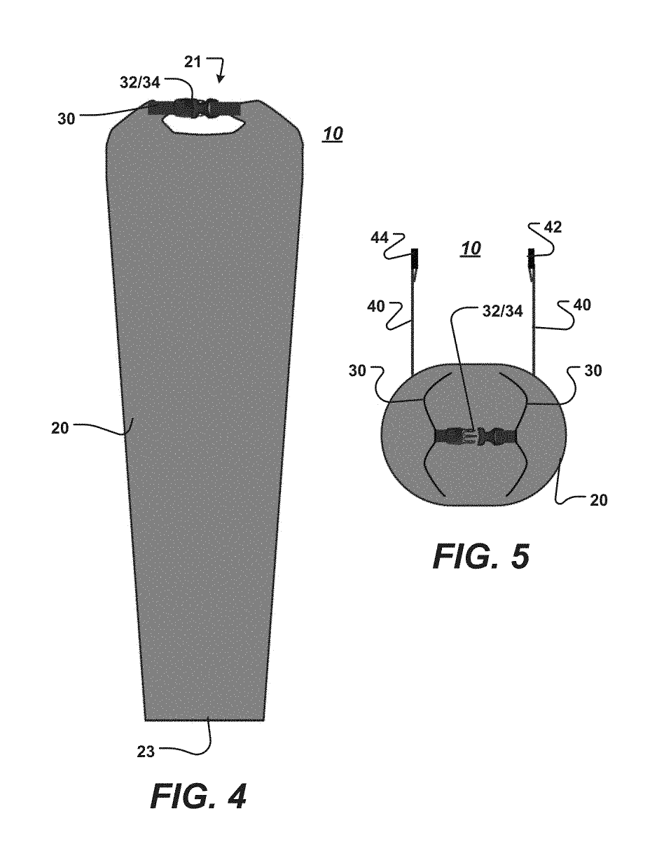

As seen in FIG. 1, the closure device may be integrally formed with or affixed to the feeder device. The closure device comprises a sealing member 30 that allows a user to securely close and lock the top end of the feeder device in a closed configuration (shown in FIGS. 4-7), thereby preventing access to the feed chamber (or the feed therein). The seal member 30 may include a strap that may be affixed to or integrally formed with feeder device housing 20—such as, for example, around the perimeter or rim of the opening 21 in the feeder device. The sealing member 30 may include a seal lock 32/34. The seal lock 32/34 may be the same as or similar to the mount lock 42/44. It is contemplated that the seal lock 32/34 may differ from the mount lock 42/44.

The seal member 30 may include a form member (not shown) that maintains a predetermined shape of the top portion of the feeder device. The predetermined shape may include, for example, a circular shape, an elliptical shape, or any other shape that maintains the shape of the opening 21 at the top of the feeder device to allow for easy access to the feed chamber through the top portion of the feeder device. The form member (not shown) may include, for example, metal ring, a shaped metal strip (e.g., having a semi-elliptical, semi-circular, bent, or the like shape), a memory metal, a malleable metal, or the like, that maintains the shape of the opening 21 until the user applies a force sufficient to collapse and close the opening 21. The top portion (of the feeder device which may form a portion of the closure device) may then be rolled or folded (e.g., one or more times) toward to the bottom end of the feeder device and the seal lock 32/34 may then be engaged, as seen in FIGS. 4-7, to seal and secure the top portion of the feeder device in a closed configuration, thereby waterproofing, tamper-proofing, and sealing the feeder apparatus.

The form member may be integrally formed with, inserted in, or affixed to a portion of, or the entirety of the perimeter around the opening 21, which may be in the shape of a rim or ring. For instance, the form member may include a single metal ring that is inserted in, formed with, or affixed to the rim at the top portion of the feeder device, or one or more pieces of memory metal that are inserted in, formed with, or affixed to the rim that surrounds the opening 21.

FIG. 2 shows a back view of the feeder apparatus in the open configuration. In the embodiment shown in FIG. 2, the feeder apparatus comprises four mounting fasteners 40, pairs of which may be connected and secured to each other by means of mount locks 42/44. The mounting fasteners 40 may be positioned closer to the top end of the feeder apparatus, so as to provide stability and allow for easier filling of feed into the feed chamber when attached to a vertical object such as a tree or pole.

FIG. 3 shows a top-down view of the feeder apparatus in the open configuration, showing the feeder apparatus through the opening 21, down the feeder chamber and finally through the opening 23 at the bottom end of the feeder device.

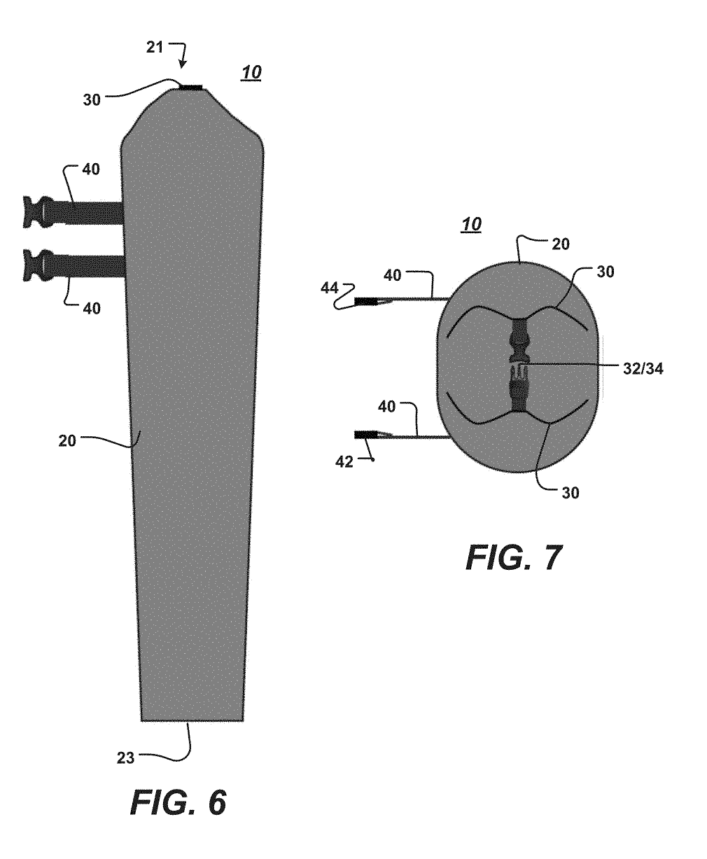

FIGS. 4 and 6 show front and side views, respectively, of the feeder apparatus in the closed configuration. In this example, the top portion of the feeder apparatus has been rolled (or folded) one or more times and the sealing member 30 secured and locked by means of seal lock 32/34 to seal the top portion of the feeder device, and, thereby, the top portion of the feeder chamber, leaving only the opening 23 at the bottom end of the feeder apparatus open for feed to pass through.

FIGS. 5 and 7 show the top view of the feeder apparatus in the closed configuration, with the seal lock 32/34 in the pre-lock position—that is, just before the male portion 32 of the seal lock 32/34 is inserted into and locked in the female portion 34.

According to one non-limiting embodiment of the disclosure, the animal feeder apparatus comprises a feeder device that has a housing made of a resilient and flexible material (such as, e.g., flexible PVC fabric), which may be formed as one piece into an elongated funnel fashion. The top portion of the feeder apparatus has a waterproof PVC fabric roll top, which has a rim that may contain a form member (for example, a piece of malleable metal) to allow a user to keep the top portion of the feeder apparatus in an open configuration while the apparatus is being filled, cleaned or inspected. Once the feeder apparatus has been filled, cleaned or inspected the top portion may be collapsed, rolled a number of times and then clipped or strapped into the sealed position by means of the sealing member. In the sealed position the feeder apparatus is waterproof, varmint proof and spill proof due to the design. Gravity causes the feed in the feeder apparatus to flow at a controlled rate through the bottom of the apparatus, which may be regulated by close but adjustable proximity to the ground, as animals consume the feed. Reliance on gravitational forces in lieu of mechanical drivers allows the user to feed a plurality of feed types including but not limited to corn, grains, protein pellets, protein powders, attractants, salts and mixtures of the foregoing individually or simultaneously.

Referring to FIGS. 1-5, according to one non-limiting application of the feeder apparatus, a user (e.g., a hunter) may unfold the feeder apparatus to the open configuration shown in FIGS. 1-3. The user may then position the back end of the feeder apparatus against a vertical object (e.g., a tree) such that the bottom end of the feeder apparatus is only a few inches from the ground. Pairs of the mounting fasteners 40 may then be wrapped around the vertical object and secured to each other (and the vertical object) by means of the mount locks 42/44, thereby securing the feeder apparatus to the vertical object in the desired position. The user may then p feed into the feed chamber (shown in FIG. 3) through the opening 21. A portion of the feed will pass through the feed chamber and the opening 23 to land on the ground underneath the feeder apparatus. The feed will continue to pass through the opening 23 until the space gap between the ground and the bottom end of the feed apparatus fills with feed, at which point the feed will stop flowing through the opening 23 and the user may fill the feed chamber to the desired level.

After the feed chamber is filled to the desired level, the user may grasp opposite portions of the rim around the opening 21 with one or both hands (depending on the diameter and/or shape of the opening 21) and press the grasped portions toward each other to collapse and close the opening 21. Alternatively, the user may push on a portion of the rim toward the vertical object, thereby using the opposite force provided by the vertical object to collapse and close the opening 21. The user may then grasp opposite corners of the top portion of the feeder device and roll or fold the housing 20 downward toward to the ground. The user may roll/fold the portion of the housing 20 one or more times, after which the user may grasp, couple and lock the sealing member 30 via the seal lock 32/34, thereby sealing the top of the feeder apparatus against weather and tampering by animals.

The animal feeder apparatus of the instant disclosure eliminates the need of a second person to hold the opening 21 in the fully open position. The roll top waterproof closure device eliminates water and moisture damage to feed(s) or proteins allowing the feeder to dispense fully and consistently from start to finish. The roll top design also prevents raccoons, opossums, squirrels and varmints of the like from unintentional top section feed access.

The terms “including,” “comprising,” and variations thereof, as used in this disclosure, mean “including, but not limited to,” unless expressly specified otherwise.

The terms “a,” “an,” and “the,” as used in this disclosure, means “one or more,” unless expressly specified otherwise.

When a single structure or article is described herein, it will be readily apparent that more than one device or article may be used in place of a single device or article. Similarly, where more than one device or article is described herein, it will be readily apparent that a single structure or article may be used in place of the more than one structure or article. The functionality or the features of a structure or article may be alternatively embodied by one or more other structures or articles that are not explicitly described as having such functionality or feature.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

What is claimed is:

1. An animal feeder apparatus, comprising:
a feeder device having a flexible housing that has a first end and a second end; and
a closure device having a sealing member that comprises a portion of the flexible housing and the second end of the feeder device,
wherein the flexible housing forms a feed chamber,
wherein the first end is tapered and comprises a first opening to the feed chamber, wherein the second end comprises a second opening to the feed chamber, and
wherein the said portion of the flexible housing is adapted to be rolled to close and seal said second opening.

2. The animal feeder apparatus according to claim 1, wherein the flexible housing has a funnel-shape.

3. The animal feeder apparatus according to claim 1, wherein the feeder device comprises a mounting fastener.

4. The animal feeder apparatus according to claim 3, wherein the mounting fastener comprises a mount lock.

5. The animal feeder apparatus according to claim 1, wherein the closure device comprises a seal member.

6. The animal feeder apparatus according to claim 5, wherein the seal member comprises a seal lock.

7. The animal feeder apparatus according to claim 5, wherein the seal member is formed around said second opening.

8. The animal feeder apparatus according to claim 5, wherein the seal member is formed near said second opening.

9. The animal feeder apparatus according to claim 1, wherein the closure device comprises a form member that maintains the shape of said second opening.
